(19) United States
(12) Patent Application Publication
(10) Pub. No.: US 2008/0228612 A1
(43) Pub. Date: Sep. 18, 2008

(54) Simultaneous determination of enterprise value and cost of unlevered equity

(76) Inventor: Stephan Schmidle, Toronto (CA)

Correspondence Address: JAMES J. STERLING, 1510 STILLWATER DRIVE, MIAMI BEACH, FL, 33141, US

(21) Appl. No.: 11/657,685

(22) Filed: Mar. 12, 2007

(51) Int. Cl. G06Q 40/00

(52) U.S. Cl. 705/35

(57) ABSTRACT

The present invention consists of methods through which the value and the cost of unlevered equity of an enterprise can be determined simultaneously through numerical searches using the enterprise cash-flow forecast. These methods improve the accuracy of and simplify enterprise valuations.

### CROSS REFERENCE TO RELATED APPLICATIONS

None

### FEDERALLY SPONSORED RESEARCH

Not applicable

### SEQUENCE LISTING OR PROGRAM

Not applicable

### BACKGROUND

This invention relates to business methods for the valuation of enterprise cash-flow forecasts. More specifically, this application describes several methods for simultaneously determining the value and the cost of unlevered equity of an enterprise through numerical searches using the information contained in the cash-flow forecast, which methods improve the accuracy of and simplify enterprise valuations.

The review of the prior art refers to the following articles and books:
1. Berk, J. B. (1997): “Necessary Conditions for the CAPM”. Journal of Economic Theory: 245-257.
2. Copeland, T., T. Koller, and J. Murrin (2000). “Valuation: Measuring and Managing the Value of Companies”. (3^{rd} ed.) New York, John Wiley, p. 475-477.
3. Koller T., M. Goedhart, and D. Wessels (2005). “Valuation: Measuring and Managing the Value of Companies”. (4^{th} ed.) New York, John Wiley, p. 300-324.
4. Schmidle, S. (2006). “Cash Flow Valuation”. Working paper. Available at http://www.ssrn.com/abstract=913984

### A. Valuation Methods

The most common enterprise valuation methods are the Discounted Cash Flow (DCF), the Adjusted Present Value (APV) and the Equity Cash Flow (ECF) methods. These methods value the enterprise or the equity by discounting forecasted cash flows. For the purposes of this application, an enterprise is defined as a business undertaking which can be described through a cash-flow forecast. An enterprise may be a corporation, part of a corporation, or not incorporated. Since an equity cash-flow forecast forms part of an enterprise cash-flow forecast, the former is also referred to as an enterprise cash-flow forecast, or simply cash-flow forecast, unless such reference would result in ambiguity.

The ECF method discounts equity cash flows, i.e. the cash flows available to the owners of the enterprise, at the cost of levered equity. As the ECF method relates directly to the valuation of the interest of the owners of the enterprise, it is commonly taken to be the theoretically correct method. It is also important to note that the cost of levered equity is, in principle, measurable directly as the expected return on the equity.

The DCF method discounts discretionary cash flows at the weighted average cost of capital. The discretionary cash flow is usually defined as EBIT×(1−tax rate)+depreciation and/or amortization—capital expenditure—change in working capital. EBIT are the earnings before interest and corporate income taxes.

The APV method discounts discretionary cash flows and tax benefits of debt separately. The discount rate used for the discretionary cash flows is the cost of unlevered equity, but the finance literature is not conclusive with regard to the discount rate to be used for the tax benefits of debt. The following discount rates have been used in the literature: the risk-free rate, the cost of debt, the cost of unlevered equity, and discount rates between the cost of debt and the cost of unlevered equity.

The practical application of the DCF, APV and ECF methods is subject to several difficulties. The ECF method is considered the most difficult to apply in practice, particularly as both the equity cash flows and the cost of levered equity are expected to change if leverage, which can be defined as the ratio of market value of debt to market value of the enterprise, changes, and because in most valuation situations only estimates for the current cost of levered equity are available.

The DCF method is considered to be the most widely used method in practical applications. In its common form (equations (1) and (2)) it may lead to valuation errors, however. In addition, if leverage changes, the weighted average cost of capital may change and hence be difficult to forecast. Therefore the DCF method is usually only used under certain restrictive assumptions, which include stable leverage.

The APV method is also considered to be theoretically correct. It appears to be the easiest method to use in practice, because the cost of unlevered equity is usually taken not to change over time. In contrast, both the cost of levered equity and the weighted average cost of capital may change over time. Difficulties relating to the implementation of the APV method include the following: (1) The cost of unlevered equity cannot be measured directly. (2) The finance literature does not come to a conclusion regarding the discount rate to be used for the tax benefits of debt (e.g. Copeland et al. 2000, p. 476f). The choice of discount rate is based on the subjective assessment of the tax-shield risk by the valuator (scientist, investment analyst, etc), as tax-shield risk, which reflects the effect of debt finance on the variance of after-tax cash flows, cannot be measured objectively. Since tax-shield risk is not measurable objectively, it is impossible to ascertain the enterprise value objectively using the APV method. (3) It can be shown that if it is required that the DCF and APV methods come to identical valuation results at the present and all future points in time then there might not exist a stable functional relationship between the weighted average cost of capital and the cost of unlevered equity. Copeland et al. (2000, p. 475) show this for the case where the tax benefits of debt are discounted at the cost of debt. The absence of such a stable functional relationship makes it very difficult to ensure that the equivalence between the APV and DCF methods is maintained in practical applications. (Hereafter two or more valuation methods are said to be equivalent if they ascribe identical enterprise values to a given enterprise cash-flow forecast.) Stated differently, the DCF and APV methods, as given in equations (1) through (3), are not necessarily equivalent, and thus the valuation results obtained by the DCF and APV methods will not necessarily be consistent.

### B. Technical Description of the Valuation Methods

In its most general form the DCF method is defined as

$$\begin{matrix}{V}_{t} = {\sum }_{m = t + 1}^{T} \frac{{C}_{m}}{{\prod }_{n = t + 1}^{m} ( 1 + {w}_{n} )} = \frac{{C}_{t + 1} + {V}_{t + 1}}{1 + {w}_{t + 1}} ∀ t \vert 0 \leq t < T with & ( 1 ) \\ {w}_{t + 1} = {k}_{t + 1}^{L} ( 1 - \frac{{D}_{t}}{{V}_{t}} ) + {k}_{t + 1}^{D} \frac{{D}_{t}}{{V}_{t}} ( 1 - {τ}_{t + 1} ) ∀ t \vert 0 \leq t < T , & ( 2 )\end{matrix}$$

where Vₜ=enterprise value at time t, Vₜ₊₁=enterprise value at time t+1, T=economic life of the enterprise, Cₜ₊₁=discretionary cash flow for the time period starting at time t and ending at time t+1, wₜ₊₁=weighted average cost of capital (WACC) for the time period starting at time t and ending at time t+1, kₜ₊₁^{L}=cost of levered equity for the time period starting at time t and ending at time t+1, Dₜ=market value of debt at time t, kₜ₊₁^{D}=cost of debt for the time period starting at time t and ending at time t+1, and τₜ₊₁=income tax rate applicable to interest expense during the time period starting at time t and ending at time t+1. The expression ∀t |0≦t<T is hereafter abbreviated as ∀t. V₀ is also referred to as the current value for the enterprise or the current enterprise value, and D₀ is also referred to as the current market value of debt.

In its most general form the APV method is defined as

$${V}_{t} = {\sum }_{m = t + 1}^{T} \frac{{C}_{m}}{{\prod }_{n = t + 1}^{m} ( 1 + {k}_{n}^{U} )} + {\sum }_{m = t + 1}^{T} \frac{{d}_{m - 1} {i}_{m} {τ}_{m}}{{\prod }_{n = t + 1}^{m} ( 1 + {k}_{n}^{Tax} )} ∀ t , \qquad ( 3 )$$

where dₜ=book value of debt at time t, iₜ₊₁=interest rate for the time period starting at time t and ending at time t+1, kₜ₊₁^{U}=cost of unlevered equity for the time period starting at time t and ending at time t+1, and kₜ₊₁^{Tax}=discount rate for the tax benefits of debt for the time period starting at time t and ending at time t+1. d₀ is also referred to as the current book value of debt, and i₁ is also referred to as the current interest rate. If the cost of unlevered equity is used to discount the tax benefits of debt, then the APV method can be simplified as follows:

$$\begin{matrix}{V}_{t} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} = \frac{{C}_{t + 1} + {d}_{t} {i}_{t + 1} {τ}_{i + 1} + {V}_{t + 1}}{1 + {k}_{t + 1}^{U}} ∀ t with & ( 4 ) \\ {k}_{k + 1}^{U} = {k}_{t + 1}^{L} ( 1 - \frac{{D}_{t}}{{V}_{t}} ) + {k}_{t + 1}^{D} \frac{{D}_{t}}{{V}_{t}} & ( 5 )\end{matrix}$$

Equation (4) is referred to as the Capital Cash Flow (CCF) method. If the CCF method is used then the current value of the cost of unlevered equity can be calculated based on the current cost of levered equity k₁^{L}, the current cost of debt k₁^{D}, and the current leverage, which is defined as the ratio of the current market value of debt to the current enterprise value:

$${k}_{1}^{U} = {k}_{1}^{L} ( 1 - \frac{{D}_{0}}{{V}_{0}} ) + {k}_{1}^{D} \frac{{D}_{0}}{{V}_{0}} \qquad ( 6 )$$

The ECF method can be defined as follows:

$$\begin{matrix}\begin{matrix}{E}_{t} = {\sum }_{m = t + 1}^{T} \frac{{C}_{m} - {d}_{m - 1} {i}_{m} ( 1 - {τ}_{m} ) + Δ {d}_{m}}{{\prod }_{n = t + 1}^{m} ( 1 + {k}_{n}^{L} )} \\ = \frac{{C}_{t + 1} - {d}_{t} {i}_{t + 1} ( 1 - {τ}_{t + 1} ) + Δ {d}_{t + 1} + {E}_{t + 1}}{1 + {k}_{t + 1}^{L}} ∀ t with\end{matrix} & ( 7 ) \\ {k}_{t + 1}^{L} = \frac{{C}_{t + 1} - {d}_{t} {i}_{t + 1} ( 1 - {τ}_{t + 1} ) + Δ {d}_{t + 1} + {E}_{t + 1}}{{E}_{t}} - 1 & ( 8 )\end{matrix}$$

where Eₜ=equity value at time t, Eₜ₊₁=equity value at time t+1, and Δdₜ₊₁=change of book value of debt during the time period starting at time t and ending at time t+1.

### C. Estimating Discount Rates

One of the most challenging areas when valuing an enterprise is to forecast the discount rates to apply to the cash flows. In the preceding sections I have pointed out several difficulties already. This section now focuses on how discount rates are estimated in practice. The weighted average cost of capital (WACC) and the cost of unlevered equity are usually estimated through equations (2) and (6), respectively. In order to do so, it is necessary to forecast the cost of levered equity (methods for forecasting the cost of debt are not reviewed here). The most commonly used methods for forecasting the cost of levered equity are the capital asset pricing model (CAPM), the Fama-French Three-Factor Model and the “implied cost of capital” method. Koller et al. (2005: 300-324) provide a good overview of the different methods for establishing the cost of levered equity. There exist difficulties with each of these methods, however.

The CAPM estimates the cost of levered equity by calculating the equity beta. The most significant difficulty with respect to the CAPM is that it cannot be tested empirically, because tests of the CAPM assume knowledge of the market portfolio, i.e. the portfolio of all investment assets. However, the finance literature has not been able to devise a compelling method for combining all investment assets into a single portfolio. It is hence not possible to determine whether the CAPM is correct. In addition, the CAPM relies on very restrictive assumptions (Berk 1997), and for many corporations the equity beta is not stable over time.

The Fama-French model is a multi-factor model utilizing 3 factors, i.e. the excess market return (which is also used by the CAPM), the excess return of small stocks, and the excess return of stocks with a high book value to market value. There exists little (if any) theoretical foundation for the Fama-French model; it is purely based on empirically observed relationships.

It is also important to note that the equity beta and the Fama-French factors are not integral parts of the enterprise cash-flow forecast, but are external to it. Estimates of the equity beta and the Fama-French factors rely on statistical methods, such as correlation and regression analyses, and are historically oriented, whereas enterprise cash-flow forecasts (and valuations) are future-oriented. Further, both the CAPM and the Fama-French model are difficult to implement because neither model suggests how much historical data should be used. Are 2 years of stock returns sufficient or should 5 years be used? Thus the CAPM and the Fama-French model necessitate subjective decisions from the valuator, which, in my view, deprive both methods of predictive power.

In contrast to these historically oriented methods, the “implied cost of capital” method determines the cost of levered equity as the internal rate of return (IRR) which equates the stock price with the discounted expected dividends. The main drawback of this method is that the cost of levered equity is forecasted not to change over time, as it is defined as an IRR. In most “real life” situations it is unrealistic to expect the cost of levered equity not to change over time.

In Schmidle (2006) it is shown that equation (8) can be used to forecast the cost of levered equity. The importance of this equation will become apparent when discussing the valuation example below. The expression for the WACC commonly cited in the literature, equation (2), is in my view incorrect. It only holds if the debt is assumed to be short-term or of perpetual nature. The following equation is valid for debt of any maturity:

$${w}_{t + 1} = {k}_{t + 1}^{U} - \frac{{d}_{t} {i}_{t + 1} {τ}_{t + 1}}{{V}_{t}} = \frac{{E}_{t} {k}_{t + 1}^{L}}{{V}_{t}} + \frac{{k}_{t + 1}^{D} {D}_{t + 1} - {d}_{i} {i}_{t + 1} {τ}_{t + 1}}{{V}_{t}} \qquad ( 9 )$$

It can be shown that if kₜ₊₁^{L}, wₜ₊₁ and kₜ₊₁^{U} are estimated through equations (8), (9) and (5) respectively, then the DCF, CCF and ECF methods come to consistent valuation results at the present and all future points of time, provided that the enterprise is and remains economically viable (i.e. no bankruptcy is present or anticipated). Further, only one combination of current enterprise value and cost of unlevered equity exists (a formal proof of this statement is still outstanding). This result is important, because it implies that the concept of tax-shield risk is irrelevant for valuing an enterprise (a more detailed discussion of these issues may be found in Schmidle, 2006).

### SUMMARY

The present invention consists of methods for overcoming the difficulties noted in the preceding sections, which methods improve the accuracy of and simplify enterprise valuations. All methods described in this application simultaneously determine the enterprise value and the cost of unlevered equity through numerical searches. The main difference between the methods is the “value parameters” used. Value parameters are those parameters that reflect the valuation of the debt (k₁^{D} and D₀, which are also referred to as k₁^{D,market} and D₀^{market}, respectively) or of the equity (k₁^{L} and the current market capitalization, MC₀) of the enterprise in the market place. In the following, value parameters are said to be “determined in the capital markets”.

Methods 1 through 6 utilize combinations of two value parameters: Method 1 relies on k₁^{L} and D₀. Method 2 relies on MC₀ and D₀. Method 3 relies on k₁^{D} and D₀. Method 4 relies on k₁^{L} and k₁^{D}. Method 5 relies on k₁^{L} and MC₀. Method 6 relies on MC₀ and k₁^{D}. Several of these methods also require specification of a functional relationship between leverage and the cost of debt, kₜ₊₁^{D}=f(Dₜ/Vₜ), as an input to the valuation. In practical applications this functional relationship needs to be estimated econometrically.

Method 7 only requires one of the above value parameters, as well as kₜ₊₁^{D}=f(Dₜ/Vₜ). The reason for describing methods using two value parameters, when one is sufficient to value the enterprise, is that method 7 necessitates an explicit valuation of the debt of the enterprise. The information required to do so might not be available, however. Further, if two value parameters are reliably determined in the capital markets, then it would be unnecessarily complicated to use method 7.

The advantages of these methods are that:
1. they simplify enterprise valuations as the cost of unlevered equity does not have to be estimated separately;
2. they do not require forecasting the cost of levered equity through the methods discussed above, and thus do not encounter the problems associated with them;
3. they maintain the equivalence between the DCF, CCF and ECF methods, meaning that all three valuation methods come to the same valuation result;
4. they do not require the stringent assumptions typically required for the implementation of the DCF method; and
5. they do not depend on the subjective assessment of tax-shield risk by the valuator.

Furthermore, the valuation results of the methods are “internally consistent”, as discussed in section “EXAMPLE”.

### BRIEF DESCRIPTION OF THE DRAWINGS

FIG. 1 is a flowchart describing method 1.

### DETAILED DESCRIPTION—PREFERRED EMBODIMENT

### Method 1

This method requires that k₁^{L} and D₀ be known. The following steps implement method 1:
1. Choose a cost of unlevered equity, k₁^{U}.
2. Calculate kₜ₊₁^{U}=kₜ^{U}+Δkₜ₊₁^{U}∀t|1≦t<T.
3. Calculate V₀ through the CCF or DCF method, or a combination or variation thereof.
4. Calculate the equity value, E₀=V₀−D₀.
5. Calculate the cost of debt as a function of leverage, k₁^{D}=f(D₀/V₀).
6. Calculate k₁^{U,output} through equation (6).
7. If |k₁^{U,output}−k₁^{U}|>10⁻⁵ then update k₁^{U} and go back to step 2 else exit the iteration.

Note that Δkₜ₊₁^{U}, i.e. the anticipated change of the cost of unlevered equity can be due to a variety of reasons. In particular Δkₜ₊₁^{U} may reflect a change of the operating risk of the enterprise. Δkₜ₊₁^{U} is therefore considered to be a part of a cash-flow forecast.

### Method 2

This method requires that MC₀ and D₀ be known. The following steps implement method 2:
1. Choose a cost of unlevered equity, k₁^{U}.
2. Calculate kₜ₊₁^{U}=kₜ^{U}+Δkₜ₊₁^{U}∀t|1≦t<T.
3. Calculate V₀ through the CCF or DCF method, or a combination or variation thereof.
4. Calculate E₀=V₀−D₀.
5. If |MC₀−E₀|>10⁻⁵ then update k₁^{U} and go back to step 2 else exit the iteration.

The market capitalization, MC₀, is defined as stock price times the number of shares in issue. It can be argued that the market capitalization should be based on the fully diluted number of shares. MC₀ shall therefore be taken to refer to either interpretation.

### Method 3

This method requires that k₁^{D} and D₀ be known. The following steps implement method 3:
1. Choose a cost of unlevered equity, k₁^{U}.
2. Calculate kₜ₊₁^{U}=kₜ^{U}+Δkₜ₊₁^{U}∀t|1≦t<T.
3. Calculate V₀ through the CCF or DCF method, or a combination or variation thereof.
4. Calculate k₁^{D,output}=f(D₀/V₀).
5. If |k₁^{D}−k₁^{D,output}|>10⁻⁵ then update k₁^{U} and go back to step 2 else exit the iteration.

### Method 4

This method requires that k₁^{L} and k₁^{D} be known. The following steps implement method 4:
1. Choose a cost of unlevered equity, k₁^{U}.
2. Calculate kₜ₊₁^{U}=kₜ^{U}+Δkₜ₊₁^{U}∀t|1≦t<T.
3. Calculate V₀ through the CCF or DCF method, or a combination or variation thereof.
4. Determine D₀ so that k₁^{D}=f(D₀/V₀)
5. Calculate E₀=V₀−D₀.
6. Calculate k₁^{D}=f(D₀/V₀).
7. Calculate k₁^{U,output} through equation (6).
8. If |k₁^{U,output}−k₁^{U}|>10⁻⁵ then update k₁^{U} and go back to step 2 else exit the iteration.

### Method 5

This method requires that k₁^{L} and MC₀ be known. The following steps implement method 5:
1. Choose a cost of unlevered equity, k₁^{U}.
2. Calculate kₜ₊₁^{U}=kₜ^{U}+Δkₜ₊₁^{U}∀t|1≦t<T.
3. Calculate V₀ through the CCF or DCF method, or a combination or variation thereof.
4. Calculate D₀=V₀−MC₀.
5. Calculate k₁^{D}=f(D₀/V₀).
6. Calculate k₁^{U,output} through equation (6).
7. If |k₁^{U,output}−k₁^{U}|>10⁻⁵ then update k₁^{U} and go back to step 2 else exit the iteration.

### Method 6

This method requires that k₁^{D} and MC₀ be known. The following steps implement method 6:
1. Choose a cost of unlevered equity, k₁^{U}.
2. Calculate kₜ₊₁^{U}=kₜ^{U}+Δkₜ₊₁^{U}∀t|1≦t<T.
3. Calculate V₀ through the CCF or DCF method, or a combination or variation thereof.
4. Determine D₀ so that k₁^{D}=f(D₀/V₀).
5. Calculate E₀=V₀−D₀.
6. If |MC₀−E₀|>10⁻⁵ then update k₁^{U} and go back to step 2 else exit the iteration.

### Method 7

For this method it is sufficient that only one value parameter is known: k₁^{L}, k₁^{D,market}, MC₀, or D₀^{market}. The following steps implement method 7:
1. Choose a cost of unlevered equity, k₁^{U}.
2. Calculate kₜ₊₁^{U}=kₜ^{U}+Δkₜ₊₁^{U}∀t|1≦t<T.
3. Calculate Vₜ∀t|0≦t<T through the CCF or DCF method, or a combination or variation thereof.
4. Determine (Dₜ,kₜ₊₁^{D})∀t|0≦t<T_{D} so that Dₜ=(dₜiₜ₊₁−Δdₜ₊₁+Dₜ₊₁)/(1+kₜ₊₁^{D}) and kₜ₊₁^{D}=f(Dₜ/Vₜ) (T_{D}=maturity of the existing debt).
5. If the value parameter is k₁^{L}:
   a. Calculate E₀=V₀−D₀.
   b. Calculate

$${k}_{1}^{U , output} = \frac{{E}_{0}}{{V}_{0}} {k}_{1}^{L} + \frac{{D}_{0}}{{V}_{0}} {k}_{1}^{D}$$

c. If |k₁^{U,output}−k₁^{U}|>10⁻⁵ then update k₁^{U} and go back to step 2 else exit the iteration.
6. If the value parameter is MC₀:
   a. Calculate E₀=V₀−D₀.
   b. If |MC₀−E₀|>10⁻⁵ then update k₁^{U} and go back to step 2 else exit the iteration.
7. If the value parameter is k₁^{D,market}:
   If |k₁^{D,market}−k₁^{D}|>10⁻⁵ then update k₁^{U} and go back to step 2 else exit the iteration.
8. If the value parameter is D₀^{market}:
   If |D₀^{market}−D₀|>10⁻⁵ then update k₁^{U} and go back to step 2 else exit the iteration.

To determine D₀ in step 4 it is necessary to find a solution (D₀, k₁^{D}) that satisfies both k₁^{D}=f(D₀/V₀) and D₀=(d₀i₁−Δd₁+D₁)/(1+k₁^{D}). To determine this solution it is first necessary to determine a solution (D₁,k₂^{D}). In effect all (Dₜ,kₜ₊₁^{D}) for 0≦t<T_{D} must be determined recursively. Newton's method provides a powerful tool with which these computations may be implemented.

### Operation—Preferred Embodiment

The operation of the preferred embodiment is described through the following algorithms. Note that the outlines of the methods given above are simplifications and that the algorithms may deviate from them to some extent. The preferred embodiment assumes that book values of debt and interest rates are forecasted for the entire economic life of the enterprise. The enterprise values are then determined via equation (4). The methods detailed below therefore use the CCF method to determine enterprise value. The additional embodiment shows that the valuation methods described in this application can be used with the capital cash flow method, the discounted cash flow method, or a combination or variation thereof. The assumptions for the additional embodiment which deviate from the preferred embodiment are described at the beginning of section “DETAILED DESCRIPTION—ADDITIONAL EMBODIMENT”.

### Method 1

The following algorithm implements the preferred embodiment of method 1. For iteration purposes, the algorithm requires specification of a minimum value for k₁^{U}, which is denoted as kₘᵢₙ^{U}. Possible values for kₘᵢₙ^{U} include the cost of debt of the enterprise, if it were presently unlevered, and the risk-free interest rate.

### Input:

T, t, k₁^{L}, D₀, kₘᵢₙ^{U}
Cₜ₊₁, τₜ₊₁, dₜ, iₜ₊₁∀t
Δkₜ₊₁^{U}∀t|1≦t<T

### Algorithm:

1) Set k_{A}^{U}:=kₘᵢₙ^{U} and k_{B}^{U}:=k₁^{L}.
2) Iterate while k_{B}^{U}−k_{A}^{U}>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < T \\ c ) & {V}_{t} = {\sum }_{m = t + 1}^{T} \frac{( {C}_{m} + {d}_{m - 1} {i}_{m} {τ}_{m} )}{{\prod }_{n = t + 1}^{m} ( 1 + {k}_{n}^{U} )} ∀ t \\ d ) & {E}_{0} = {V}_{0} - {D}_{0} \\ e ) & {k}_{1}^{D} = f ( {D}_{0} / {V}_{0} ) \\ f ) & {k}_{U} = \frac{{E}_{0}}{{V}_{0}} {k}_{1}^{L} + \frac{{D}_{0}}{{V}_{0}} {k}_{1}^{D} \\ g ) & If {k}_{U} > {k}_{1}^{U} then {k}_{A}^{U} = {k}_{U} else {k}_{B}^{U} = {k}_{U} .\end{matrix} \qquad$$

Output: Vₜ, kₜ₊₁^{U}∀t

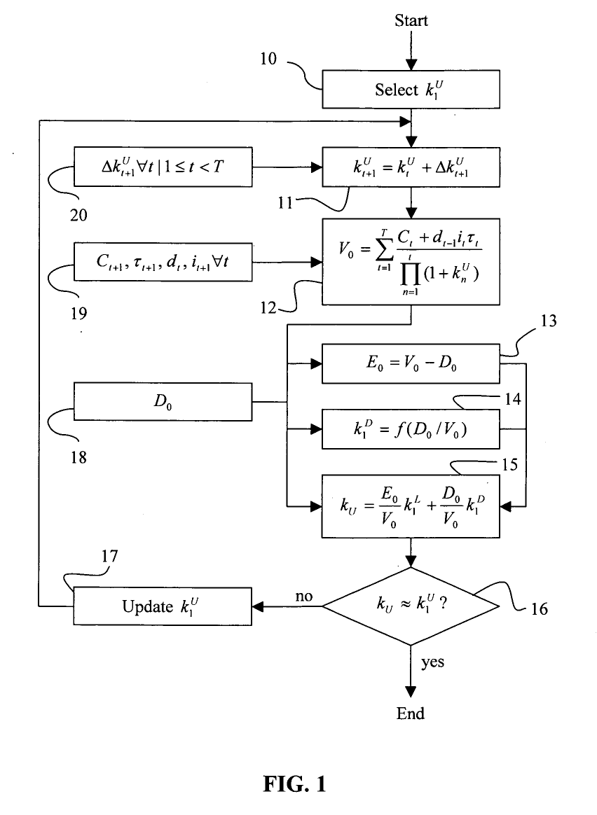

FIG. 1 is a flowchart providing a graphical representation of this method. The iteration is started by selecting a current cost of unlevered equity 10. The cost of unlevered equity for subsequent time periods 11 is calculated based on the anticipated changes of the cost of unlevered equity 20 and the current cost of unlevered equity 10. Using the costs of unlevered equity 10 and 11, and the remaining elements of the cash flow forecast 19, the current enterprise value 12 is determined. Using the current market value of debt 18 and the current enterprise value 12, the current equity value 13 and the current cost of debt 14 are calculated. The current enterprise value 12, the current equity value 13, the current cost of debt 14 and the current market value of debt 18 are used to determine the output cost of unlevered equity 15. Decision criterion 16 terminates the iteration if the current cost of unlevered equity 10 approximately equals the output cost of unlevered equity 15. Otherwise the current cost of unlevered equity 17 is updated and the iteration continued. The algorithm provides output Vₜ and kₜ₊₁^{U}∀t, whereas FIG. 1 is somewhat simplified and only shows V₀ and k₁^{U} as output. The reason for this simplification is that V₀ and k₁^{U} are sufficient to establish the equilibrium valuation, whereas Vₜ and kₜ₊₁^{U}∀t represent information that a valuator would find useful.

### Method 2

The following algorithm implements the preferred embodiment of method 2. For iteration purposes, the algorithm requires specification of a maximum value for k₁^{U}, which is denoted as kₘₐₓ^{U}. Since the current cost of unlevered equity cannot exceed the current cost of levered equity, k₁^{L}, the latter (if known) can be used for kₘₐₓ^{U}.

### Input:

T, t, kₘᵢₙ^{U}, kₘₐₓ^{U}, MC₀, D₀
Cₜ₊₁, τₜ₊₁, dₜ, iₜ₊₁∀t
Δkₜ₊₁^{U}∀t|1≦t<T

### Algorithm:

1) Set k_{A}^{U}:=kₘᵢₙ^{U} and k_{B}^{U}:=kₘₐₓ^{U}.
2) Iterate while k_{B}^{U}−k_{A}^{U}>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < T \\ c ) & {V}_{t} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} ∀ t \\ d ) & {E}_{0} = {V}_{0} - {D}_{0} \\ e ) & If {E}_{0} > {MC}_{0} then {k}_{A}^{U} = {k}_{1}^{U} else {k}_{B}^{U} = {k}_{1}^{U} .\end{matrix}$$

Output: Vₜ, kₜ₊₁^{U}∀t

### Method 3

The following algorithm implements the preferred embodiment of method 3:

### Input:

T, t, kₘᵢₙ^{U}, kₘₐₓ^{U}, k₁^{D,market}, D₀
Cₜ₊₁, τ₁₊₁, dₜ, iₜ₊₁∀t
Δkₜ₊₁^{U}∀t|1≦t<T

### Algorithm:

1) Set k_{A}^{U}:=kₘᵢₙ^{U} and k_{B}^{U}:=kₘₐₓ^{U}.
2) Iterate while k_{B}^{U}−k_{A}^{U}>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < T \\ c ) & {V}_{t} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} ∀ t \\ d ) & {k}_{1}^{D} = f ( {D}_{0} / {D}_{0} ) \\ e ) & If {k}_{1}^{D} < {k}_{1}^{D , input} then {k}_{A}^{U} = {k}_{1}^{U} else {k}_{B}^{U} = {k}_{1}^{U} .\end{matrix}$$

Output: Vₜ, kₜ₊₁^{U}∀t

### Method 4

The following algorithm implements the preferred embodiment of method 4:

### Input:

T, t, kₘᵢₙ^{U}, kₘₐₓ^{U}, k₁^{L}, k₁^{D}
Cₜ₊₁, τₜ₊₁, dₜ, iₜ₊₁∀t
Δkₜ₊₁^{U}∀t|1≦t<T

### Algorithm:

1) Set k_{A}^{U}:=kₘᵢₙ^{U} and k_{B}^{U}:=kₘₐₓ^{U}.
2) Iterate while k_{B}^{U}−k_{A}^{U}>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < T \\ c ) & {V}_{t} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} ∀ t\end{matrix}$$

d) Determine D₀ so that k₁^{D}=f(D₀/V₀).

$$\begin{matrix}e ) & {E}_{0} = {V}_{0} - {D}_{0} \\ f ) & {k}_{U} = \frac{{E}_{0}}{{V}_{0}} {k}_{1}^{L} + \frac{{D}_{0}}{{V}_{0}} {k}_{1}^{D} \\ g ) & If {k}_{U} > {k}_{1}^{U} then {k}_{A}^{U} = {k}_{U} else {k}_{B}^{U} = {k}_{U} .\end{matrix}$$

Output: Vₜ, kₜ₊₁^{U}∀t

### Method 5

The following algorithm implements the preferred embodiment of method 5:

### Input:

T, t, kₘᵢₙ^{U}, kₘₐₓ^{U}, k₁^{L}, MC₀
Cₜ₊₁, τₜ₊₁, dₜ, iₜ₊₁∀t
Δkₜ₊₁^{U}∀t|1≦t<T

### Algorithm:

1) Set k_{A}^{U}:=kₘᵢₙ^{U} and k_{B}^{U}:=kₘₐₓ^{U}.
2) Iterate while k_{B}^{U}−k_{A}^{U}>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < T \\ c ) & {V}_{t} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} ∀ t \\ d ) & {D}_{0} = {V}_{0} - {MC}_{0} \\ e ) & {k}_{1}^{D} = f ( {D}_{0} / {V}_{0} ) \\ f ) & {k}_{U} = \frac{{MC}_{0}}{{V}_{0}} {k}_{1}^{L} + \frac{{D}_{0}}{{V}_{0}} {k}_{1}^{D} \\ g ) & If {k}_{U} > {k}_{1}^{U} then {k}_{A}^{U} = {k}_{U} else {k}_{B}^{U} = {k}_{U} .\end{matrix}$$

Output: Vₜ, kₜ₊₁^{U}∀t

### Method 6

The following algorithm implements the preferred embodiment of method 6:

### Input:

T, t, kₘᵢₙ^{U}, kₘₐₓ^{U}, MC₀, k₁^{D}
Cₜ₊₁, τₜ₊₁, dₜ, iₜ₊₁∀t
Δkₜ₊₁^{U}∀t|1≦t<T

### Algorithm:

1) Set k_{A}^{U}:=kₘᵢₙ^{U} and k_{B}^{U}:=kₘₐₓ^{U}.
2) Iterate while |MC₀−E₀|>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < T \\ c ) & {V}_{t} = {\sum }_{m = t + 1}^{T} \frac{{C}_{m} + {d}_{m - 1} {i}_{m} {τ}_{m}}{{\prod }_{m = t + 1}^{m} ( 1 + {k}_{n}^{U} )} ∀ t\end{matrix}$$

d) Determine D₀ so that k₁^{D}=f(D₀/V₀).
e) E₀=V₀−D₀
f) If E₀>MC₀ then k_{A}^{U}=k₁^{U} else k_{B}^{U}=k₁^{U}.
   Output: Vₜ, kₜ₊₁^{U}∀t

### Method 7

The following algorithm implements the preferred embodiment of method 7:

### Input:

T, t, kₘᵢₙ^{U}, kₘₐₓ^{U},
Cₜ₊₁, τₜ₊₁, dₜ, iₜ₊₁∀t
Δkₜ₊₁^{U}∀t|1≦t<T
One value parameter: k₁^{L}, MC₀, k₁^{D,market}, D₀^{market}

### Algorithm:

1) Set k_{A}^{U}:=kₘᵢₙ^{U} and k_{B}^{U}:=kₘₐₓ^{U}.
2) Iterate until the condition for the selected value parameter is satisfied:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{k + 1}^{U} ∀ t \vert 1 \leq t < T \\ c ) & {V}_{t} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} ∀ t\end{matrix}$$

d) Determine (Dₜ,kₜ₊₁^{D})∀t|0≦t<T_{D} so that Dₜ=(dₜiₜ₊₁−Δdₜ₊₁+Dₜ₊₁)/(1+kₜ₊₁^{D}) and kₜ₊₁^{D}=f(Dₜ/Vₜ).
e) If the value parameter is k₁^{L}:

$$\begin{matrix}i ) & {E}_{0} = {V}_{0} - {D}_{0} \\ ii ) & {k}_{U} = \frac{{E}_{0}}{{V}_{0}} {k}_{1}^{L} + \frac{{D}_{0}}{{V}_{0}} {k}_{1}^{D}\end{matrix}$$

iii) If |k_{U}−k₁^{U}|≦10⁻⁵ stop iterating; otherwise if k_{U}>k₁^{U} then k_{A}^{U}=k₁^{U} else k_{B}^{U}=k₁^{U}.
f) If the value parameter is MC₀:
   i) Calculate E₀=V₀−D₀.
   ii) If |MC₀−E₀|≦10⁻⁵ stop iterating; otherwise if E₀>MC₀ then k_{A}^{U}=k₁^{U} else k_{B}^{U}=k₁^{U}.
g) If the value parameter is k₁^{D,market}: If |k₁^{D,market}−k₁^{D}|>10⁻⁵ stop iterating; otherwise if k₁^{D,market}>k₁^{D} then k_{A}^{U}=k₁^{U} else k_{B}^{U}=k₁^{U}.
h) If the value parameter is D₀^{market}: If |D₀^{market}−D₀|≦10⁻⁵ stop iterating; otherwise if D₀^{market}<D₀ then k_{A}^{U}=k₁^{U} else k_{B}^{U}=k₁^{U}.
   Output: Vₜ, kₜ₊₁^{U}∀t

### Detailed Description—Additional Embodiment

It is customary not to forecast the entire enterprise life, but to assume a constant growth rate for the discretionary cash flows following the explicit forecast period. The enterprise life T is usually assumed to approach infinity. In addition, the maturity of the existing debt may be shorter than the explicit forecast period. If leverage ratios, Dₜ/Vₜ, are forecasted following the refinancing of the existing debt, then equation (4) is replaced by equations (10) through (12):

$${V}_{t} = \frac{{C}_{t + 1}}{{k}_{t + 1}^{U} - \frac{{D}_{t}}{{V}_{t}} {k}_{t + 1}^{D} {τ}_{t - 1}} for t = {t}_{1} - 1 , \qquad ( 10 )$$

where g=growth rate following the explicit forecast period,

$$\begin{matrix}{V}_{t} = \frac{{C}_{t + 1} + {V}_{t + 1}}{1 + {k}_{t + 1}^{U} - \frac{{D}_{t}}{{V}_{t}} {k}_{t + 1}^{D} {τ}_{t + 1}} ∀ t \vert {t}_{2} \leq t < {t}_{1} - 1 , and & ( 11 ) \\ {V}_{t} = \frac{{C}_{t + 1} + {d}_{t} {i}_{t + 1} {τ}_{t + 1} + {V}_{t + 1}}{1 + {k}_{t + 1}^{U}} ∀ t \vert 0 \leq t < {t}_{2} , & ( 12 )\end{matrix}$$

where t₁ is the time until the end of the explicit forecast period, and t₂ is the time until the maturity of the existing debt. Equations (10) through (12) are a combination of the DCF and CCF methods. Given a functional relationship between leverage and the cost of debt, kₜ₊₁^{D}=f(Dₜ/Vₜ), the cost of debt for t≦t₂ is uniquely determined because Dₜ/Vₜ are input parameters. Equations (10) and (11) imply that the forecasted leverage ratios refer to short-term debt. Debt is considered short-term if its maturity is shorter than or equal to the forecast time period. This definition does not imply that short-term debt must carry the interest rate of true short-term debt. It is only required that the interest rate is readjusted at the latest at the end of each forecast time period to reflect the cost of debt at that time.

### Operation—Additional Embodiment

The operation of the additional embodiment is described through the following algorithms. Because of the similarities between the algorithms, only methods 1 through 3 are described explicitly in this section.

### Method 1

The following algorithm implements the additional embodiment of method 1:

### Input:

g, t₁, t₂, k₁^{L}, kₘᵢₙ^{U}, D₀
Cₜ₊₁, τₜ₊₁∀t|0≦t<t₁
dₜ, iₜ₊₁∀t|0≦t<t₂
(Dₜ/Vₜ)∀t|t₂≦t<t₁
Δkₜ₊₁^{U}∀t|1≦t<t₁

### Algorithm:

1) kₜ₊₁^{D}=f(Dₜ/Vₜ)∀t|t₂≦t<t₁
2) Set k_{A}^{U}:=kₘᵢₙ^{U} and k_{B}^{U}:=k₁^{L}.
3) Iterate while k_{A}^{U}−k_{B}^{U}>10⁻⁵

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < {t}_{1} \\ c ) & {V}_{t} = \frac{{C}_{t + 1}}{{k}_{t + 1}^{U} - \frac{{D}_{t}}{{V}_{t}} {k}_{t + 1}^{D} {τ}_{t + 1} - g} for t = {t}_{1} - 1 \\ d ) & {V}_{t} = \frac{{C}_{t + 1} + {V}_{t + 1}}{1 + {k}_{t + 1}^{U} - \frac{{D}_{t}}{{V}_{t}} {k}_{t + 1}^{D} {τ}_{t + 1}} ∀ t \vert {t}_{2} \leq t < {t}_{1} - 1 \\ e ) & {V}_{t} = \frac{{C}_{t + 1} + {d}_{t} {i}_{t + 1} {τ}_{t + 1} + {V}_{t + 1}}{1 + {k}_{t + 1}^{U}} ∀ t \vert 0 \leq t < {t}_{2} \\ f ) & {E}_{0} = {V}_{0} - {D}_{0} \\ g ) & {k}_{1}^{D} = f ( {D}_{0} / {V}_{0} ) \\ h ) & {k}_{U} = \frac{{E}_{0}}{{V}_{0}} {k}_{1}^{L} + \frac{{D}_{0}}{{V}_{0}} {k}_{1}^{D} \\ i ) & If {k}_{U} > {k}_{1}^{U} then {k}_{A}^{U} = {k}_{U} else {k}_{B}^{U} = {k}_{U} .\end{matrix}$$

Output: Vₜ, kₜ₊₁^{U}∀t|0≦t<t₁

### Method 2

The following algorithm implements the additional embodiment of method 2:

### Input:

g, t₁, t₂, kₘᵢₙ^{U}, kₘₐₓ^{U}, MC₀, D₀
Cₜ₊₁, τₜ₊₁∀t|0≦t<t₁
dₜ, iₜ₊₁∀t|0≦t<t₂
(Dₜ/Vₜ)∀t|t₂≦t<t₁
Δkₜ₊₁^{U}∀t|1≦t<t₁

### Algorithm:

1) kₜ₊₁^{D}=f(Dₜ/Vₜ)∀t|t₂≦t<t₁
2) Set k_{A}^{U}:=kₘᵢₙ^{U} and k_{B}^{U}:=kₘₐₓ^{U}.
3) Iterate while k_{B}^{U}−k_{A}^{U}>10⁻⁵

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < {t}_{1} \\ c ) & {V}_{t} = \frac{{C}_{t + 1}}{{k}_{t + 1}^{U} - \frac{{D}_{t}}{{V}_{t}} {k}_{t + 1}^{D} {τ}_{t + 1} - g} for t = {t}_{1} - 1 \\ d ) & {V}_{t} = \frac{{C}_{t + 1} + {V}_{t + 1}}{1 + {k}_{t + 1}^{U} - \frac{{D}_{t}}{{V}_{t}} {k}_{t + 1}^{D} {τ}_{t + 1}} ∀ t \vert {t}_{2} \leq t < {t}_{1} - 1 \\ e ) & {V}_{t} = \frac{{C}_{t + 1} + {d}_{t} {i}_{t + 1} {τ}_{t + 1} + {V}_{t + 1}}{1 + {k}_{t + 1}^{U}} ∀ t \vert 0 \leq t < {t}_{2} \\ f ) & {E}_{0} = {V}_{0} - {D}_{0} \\ g ) & If {E}_{0} > {MC}_{0} then {k}_{A}^{U} = {k}_{1}^{U} else {k}_{B}^{U} = {k}_{1}^{U} .\end{matrix}$$

Output: Vₜ, kₜ₊₁^{U}∀t|0≦t<hd 1

### Method 3

The following algorithm implements the additional embodiment of method 3:

### Input:

g, t₁, t₂, kₘᵢₙ^{U}, kₘₐₓ^{U}, k₁^{D,market}, D₀
Cₜ₊₁, τₜ₊₁∀t|0≦t<t₁
dₜ, iₜ₊₁∀t|0≦t<t₂
(Dₜ/Vₜ)∀t|t₂≦t<t₁
Δkₜ₊₁^{U}∀t|1≦t<t₁

### Algorithm:

1) kₜ₊₁^{D}=f(Dₜ/Vₜ)∀t|t₂≦t<t₁
2) Set k_{A}^{U}:=kₘᵢₙ^{U} and k_{B}^{U}:=kₘₐₓ^{U}.
3) Iterate while k_{B}^{U}−k_{A}^{U}>10⁻⁵:

$$\begin{matrix}a ) & {k}_{1}^{U} = \frac{{k}_{A}^{U} + {k}_{B}^{U}}{2} \\ b ) & {k}_{t + 1}^{U} = {k}_{t}^{U} + Δ {k}_{t + 1}^{U} ∀ t \vert 1 \leq t < {t}_{2} \\ c ) & {V}_{t} = \frac{{C}_{t + 1}}{{k}_{t + 1}^{U} - \frac{{D}_{t}}{{V}_{t}} {k}_{t + 1}^{D} {τ}_{t + 1} - g} for t = {t}_{1} - 1 \\ d ) & {V}_{t} = \frac{{C}_{t + 1} + {V}_{t + 1}}{1 + {k}_{t + 1}^{U} - \frac{{D}_{t}}{{V}_{t}} {k}_{t + 1}^{D} {τ}_{t + 1}} ∀ t \vert {t}_{2} \leq t < {t}_{1} - 1 \\ e ) & {V}_{t} = \frac{{C}_{t + 1} + {d}_{t} {i}_{t + 1} {τ}_{t + 1} + {V}_{t + 1}}{1 + {k}_{t + 1}^{U}} ∀ t \vert 0 \leq t < {t}_{2} \\ f ) & {E}_{0} = f ( {V}_{0} / {D}_{0} ) \\ g ) & If {k}_{1}^{D} < {k}_{1}^{D , input} then {k}_{A}^{U} = {k}_{1}^{U} else {k}_{B}^{U} = {k}_{1}^{U} .\end{matrix}$$

Output: Vₜ, kₜ₊₁^{U}∀t|0≦t<t₁

### EXAMPLE

An example, which is given in table 1, may be helpful to understand the invention. Panel 1 of table 1 contains the enterprise cash-flow forecast as well as the current cost of levered equity (the value parameter), and panel 2 the valuation performed by the computer program function Overall, which incorporates the variation of the additional embodiment of method 7 described in section CONCLUSION, RAMIFICATION, AND SCOPE (where the value parameter is the current cost of levered equity), forecasts the cost of levered equity (equation (8)) and values the debt. Essentially an overall equilibrium solution (V₀,k₁^{U}) is found that ensures that the valuation of the debt and the valuation of the enterprise are mutually consistent. Panel 3 through 6 contain explicit CCF, DCF, ECF and debt valuations. Note that function Overall utilizes Newton's method, whereas the algorithms described above employ interval bisection.

TABLE 1
Valuation Example

| | t = | | | | | |
|---|---|---|---|---|---|---|
| | 0 | 1 | 2 | 3 | 4 | 5 |
| Panel 1: Enterprise forecast | | | | | | |
| Discretionary cash flow | | 90 | 100 | 100 | 120 | 125 |
| Long-term growth rate | | | | | | 4.0% |
| Interest rate | | 9.0% | 10.0% | 11.0% | | |
| Existing debt at book | 700 | 673 | 640 | | | |
| Target debt-value ratio following | | | | 45.0% | 42.0% | |
| refinancing | | | | | | |
| Tax rate | | 30% | 30% | 35% | 35% | 35% |
| Cost of levered equity | | 15.0% | | | | |
| Change of cost of unlevered equity | | | 0.50% | 0.50% | | −0.75% |
| (percentage points) | | | | | | |
| Base rate for cost of debt | | 6.0% | 6.2% | 6.4% | 6.6% | 6.8% |
| Panel 2: Valuation using Method 1 | | | | | | |
| Enterprise value | 1619 | 1693 | 1772 | 1865 | 1952 | |
| Cost of unlevered equity | | 11.3% | 11.8% | 12.3% | 12.3% | 11.5% |
| Cost of debt | | 7.0% | 7.0% | 7.1% | 7.5% | 7.6% |
| Market value of debt | 751 | 714 | 664 | 839 | 820 | |
| Cost of levered equity | | 15.0% | 15.2% | 15.4% | 16.2% | 14.4% |
| Panel 3: CCF valuation | | | | | | |
| Discretionary cash flow | | 90 | 100 | 100 | 120 | 125 |
| Tax benefit of debt | | 19 | 20 | 25 | 22 | 22 |
| Capital cash flow | | 109 | 120 | 125 | 142 | 147 |
| Cost of unlevered equity | | 11.3% | 11.8% | 12.3% | 12.3% | 11.5% |
| Enterprise value | 1619 | 1693 | 1772 | 1865 | 1952 | |
| Panel 4: ECF valuation | | | | | | |
| Book value of debt | 700 | 673 | 640 | 839 | 820 | 853 |
| Discretionary cash flow | | 90 | 100 | 100 | 120 | 125 |
| After-tax interest payable | | 44 | 47 | 46 | 41 | 41 |
| Change of book value | | −27 | −33 | 199 | −19 | 33 |
| Equity cash flow | | 19 | 20 | 253 | 60 | 117 |
| Cost of levered equity (eq. 8) | | 15.0% | 15.2% | 15.4% | 16.2% | 14.4% |
| Equity value | 868 | 979 | 1108 | 1026 | 1132 | |
| Market value of debt | 751 | 714 | 664 | 839 | 820 | |
| Enterprise value | 1619 | 1693 | 1772 | 1865 | 1952 | |
| Panel 5: DCF valuation | | | | | | |
| Discretionary cash flow | | 90 | 100 | 100 | 120 | 125 |
| WACC (equation 9) | | 10.1% | 10.6% | 10.9% | 11.1% | 10.4% |
| Enterprise value | 1619 | 1693 | 1772 | 1865 | 1952 | |
| Panel 6: Market value of debt | | | | | | |
| Interest | | 63 | 67 | 70 | | |
| Principal | | 27 | 33 | 640 | | |
| Total cash flow | | 90 | 100 | 711 | | |
| Cost of debt | | 7.0% | 7.0% | 7.1% | | |
| Market value of debt | 751 | 714 | 664 | | | |

For the purposes of this example, the cost of debt, kₜ₊₁^{D}=f(Dₜ/Vₜ), is forecasted as a base rate, rₜ₊₁^{B}, plus a “leverage premium”:

kₜ₊₁^{D}=rₜ₊₁^{B}+exp(−6.902165+4.227849·Dₜ/Vₜ) (13)

The following observations can be made regarding this example:
1. The valuation in panel 2, which is performed through Method 1, is identical to the explicit valuations in panels 3 through 6.
2. Valuing the enterprise “one year out”, i.e. using t=1 as the base year instead of t=0 would result in an identical valuation. This valuation would use k₂^{L} as forecasted in panel 2 as an input.
3. Applying method 1 onto its own results would leave the valuation unchanged.

Based on these observations I call the valuation “internally consistent”.

### Computer Program

The valuation in panel 2 of table 1 has been performed using the computer program given below. The programming language is Visual Basic for Microsoft Excel (version 6.3). The computer program can be started through the following steps: (1) Start Microsoft Excel. (2) Start the Visual Basic Editor. (3) Insert a Module. (4) Copy the computer program into the Module. The computer program can then be implemented in Excel-based financial models as a user-defined function. Variable definitions are as follows:

TABLE 2
Variable definitions for function Overall

| Variable | Parameter |
|---|---|
| CashFlow | (C₁, . . . ,Cₜ_{₁}) |
| GrowthRate | g |
| DebtBookValue | (d₀, . . . ,dₜ_{₂}) |
| InterestRate | (i₁, . . . ,iₜ_{₂}₊₁) |
| TaxRate | (τ₁, . . . ,τₜ_{₁}) |
| TargetDVR | (Dₜ_{₂}₊₁/Vₜ_{₂}₊₁, . . . ,Dₜ_{₁}₊₁/Vₜ_{₁}₊₁) |
| CostLevEquity | k₁^{L} |
| BaseRate | (r₁^{B}, . . . ,rₜ_{₁}^{B}) |
| kU_Change | (Δk₁^{U}, . . . ,Δkₜ_{₁}^{U}) |

Note that in this program Δk₁^{U} forms part of the input array (Δk₁^{U}, . . . , Δkₜ_{₁}^{U}), but Δk₁^{U} is not used in the valuation.

### CONCLUSION, RAMIFICATION, AND SCOPE

In the Description and Operation sections certain assumptions are made. The methods described in this application can be adjusted to accommodate alternative assumptions, some of which are discussed as follows. But note that some of these alternative assumptions might be computationally very complex to implement.
1. The time period of the enterprise cash-flow forecast is one year. Alternative assumption: Shorter and longer time periods may be used.
2. Time periods are assumed to be of uniform length. Alternative assumption: Time periods may be of different lengths.
3. Cash flows are taken to be available for discounting at the end of the respective time periods. Alternative assumption: Cash flows may also occur during the time periods.
4. The existing debt matures before the end of the existing forecast period. Alternative assumption: The existing debt may mature at the end or after the explicit forecast period.
5. Interest is payable at the end of the time period, i.e. interest is payable in arrears. Alternative assumption: Interest can also be payable in advance or at certain points in time during the time period.
6. The change of the cost of unlevered equity is forecasted as kₜ₊₁^{U}=kₜ^{U}+Δkₜ₊₁^{U}. Alternative assumption: The change of the cost of unlevered equity may be forecasted differently as long as the cost of unlevered equity is uniquely determined for each time period. For instance, the change of the cost of unlevered equity can be forecasted as a percentage change.
7. Income tax rates within the definition of the discretionary cash flow equal the tax rate applicable to interest expense. Alternative assumption: Income tax rates within the definition of the discretionary cash flow may be different to the tax rate applicable to interest expense.
8. The debt issued to replace the existing debt at maturity is assumed to be short-term. Alternative assumption: The newly issued debt need not be short-term.

The numerical values and the functional relationship in (13) apply only to the example. Any other functional relationship between leverage and cost of debt may be used as long as said relationship exists over the entire domain and has a non-negative slope. (Even relationships with a negative slope are technically admissible under certain restrictions.) The cost of debt may also be modeled as a function of additional factors, e.g. balance-sheet liquidity. Leverage need not be defined as the ratio of market value of debt to enterprise value. For instance, leverage can be defined as the debt equity ratio.

If the maturity of the existing debt does not coincide with the length of the time period, then the cost of debt kₜ₊₁^{D} must be understood to be an appropriate average of the expected costs of debt during that time period.

The method described in this application primarily relates to enterprise cash-flow forecasts, but can also be applied to sets of historical cash flows.

One of the key parameters in financial valuations is the debt. It can be argued that it is theoretically more appropriate to use net debt, i.e. the debt less cash balances in excess of operating needs, instead of “straight” debt. The term “debt” throughout this application should thus be understood to refer to either interpretation.

The existing debt may consist of different types, including debt-like obligations such as equipment leases, and need not have a single maturity. A blend of maturities, with a more complex refinancing schedule, can be considered. Additional equity securities, e.g. preferred stock, may also be considered.

The steps in the various methods may be reordered. For instance, method 7, where the value parameter is the current cost of levered equity, can also be implemented through the following algorithm:
1. The current and future market values of debt are determined by discounting the debt cash flows, consisting of interest and principal payments, at the current and future costs of debt.
2. Using these market values of debt the enterprise is valued using method 1.
3. Based on the market values of debt and the enterprise values the current and future costs of debt are determined.

Steps 1 through 3 are repeated until an equilibrium solution obtains. An implementation of these considerations for the additional embodiment of method 1 is given in the computer program function Overall.

Most numerical searches described in this application employ a technique called “interval bisection” for determining the equilibrium solution for the cost of unlevered equity and the enterprise value. Interval bisection is used for its simplicity and robustness. However other techniques can be used as well. The computer program, for instance, utilizes Newton's method.

The preferred and additional embodiments of the present invention make certain assumptions regarding how the cash-flow forecast is structured. For instance, the preferred embodiment assumes that the explicit forecast covers the economic life of the enterprise, and that book values of debt and interest rates are forecasted for the entire life of the enterprise. Clearly, many other possible structures of cash-flow forecasts can be accommodated. For instance, it is possible to forgo forecasts of book values of debt and interest rates, and forecast target leverage ratios starting with the present time.

Many of the equations in this application can be presented in alternative forms. This can be done by utilizing equations that are always true in the valuation context, e.g. Vₜ=Eₜ+Dₜ or the CCF method. Since it is impossible to describe all the possible manifestations of the equations, this application should be understood not to be limited to the manifestations described in this application. These alternative specifications are functionally equivalent to the methods described, as they result in identical valuations. Some alternative specifications of the preferred embodiment method 1 are as follows:
1. It is possible to calculate the WACC, w₁, in step 4(f) instead of k₁^{U}, which can then be determined as k₁^{U}=w₁+d₀i₁τ₁/V₀.
2. It is possible to replace steps 4(f) and (g) with an alternative step, in which the cost of levered equity is determined as k₁^{L}=(C₁−d₀i₁(1−τ₁)+Δd₁+E₁)/E₀−1. The cost of unlevered equity is then changed until the input cost of unlevered equity equals the computed k₁^{L}.
3. It is possible to split the determination of k₁^{U} into several steps. For instance, it is possible to determine an “implied” cost of levered equity which assumes that the enterprise's debt is short-term. The following algorithm first determines combinations of short-term debt, Dₜ*, and cost of debt, kₜ₊₁^{D}*, so that Dₜ*kₜ₊₁^{D}*=dₜiₜ₊₁, and then adjusts the cost of levered equity (as observed in the market place) to conform with this “implied” short-term leverage (step 4f).

### Input:

T, t, k₁^{L}, D₀, D₁
Cₜ₊₁, τₜ₊₁, dₜ, iₜ₊₁∀t
Δkₜ₊₁^{U}∀t|1≦t<T

### Algorithm:

1) Δd₁=d₁−d₀

### 2) ΔD₁=D₁−D₀

3) Set k_{A}^{L}:=k₁^{L} and k_{B}^{L}:=0.
4) Iterate while |k_{B}^{L}−k_{A}^{L}|>10⁻⁵:
a) k_{B}^{L}=k_{A}^{L}
b) Set the range for the implied short-term debt-value ratio D₀*/V₀ to be considered: a:=0 and b:=1.
c) Iterate while b−a>10⁻⁵:

$$\begin{matrix}i ) & c = ( a + b ) / 2 \\ ii ) & {k}_{1}^{D *} = f ( c ) \\ iii ) & {k}_{1}^{U} = ( 1 - c ) \cdot {k}_{B}^{L} + c \cdot {k}_{1}^{D} \\ iv ) & {k}_{t + 1}^{U} = {k}_{t}^{U} + Δ {k}_{t + 1}^{U} ∀ t \vert 1 \leq t < T \\ v ) & {V}_{t}^{CCF} = {\sum }_{m = t + 1}^{T} \frac{{C}_{m} + {d}_{m - 1} {i}_{m} {τ}_{m}}{{\prod }_{n = t + 1}^{m} ( 1 + {k}_{n}^{U} )} ∀ t \\ vi ) & {D}_{0}^{*} = {i}_{1} {d}_{0} / {k}_{1}^{D *} \\ vii ) & {V}_{0}^{DCF} = \frac{{k}_{B}^{L} - {k}_{1}^{D}}{{k}_{B}^{L} - {k}_{1}^{U}} {D}_{0}^{*} \\ viii ) & If {V}_{0}^{DCF} > {V}_{0}^{CCF} then a := c else b := c . \\ d ) & {E}_{0} = {V}_{0}^{CCF} - {D}_{0}^{*} \\ e ) & {E}_{0} = {V}_{0}^{CCF} - {D}_{0}^{*} \\ f ) & {k}_{A}^{L} = \frac{{k}_{1}^{L} {E}_{0} + Δ {D}_{1} - Δ {d}_{1}}{{E}_{0}} \\ g ) & {k}_{1}^{L} = {k}_{A}^{L}\end{matrix}$$

5) Determine Dₜ* by iterating Dₜ*=dₜi₊₁/kₜ₊₁^{D}* with
k₁^{D}*=f(Dₜ*/Vₜ^{CCF})∀t|1≦t<T.
   6) kₜ₊₁^{D}*=f(Dₜ*/Vₜ^{CCF})∀t|1≦t<T

### Output:

Vₜ, kₜ₊₁^{U}∀t

### Computer Program

Option Base 1
Option Explicit
Function Overall(CashFlow, GrowthRate, DebtBookValue, _{—}

| | |
|---|---|
| | InterestRate, TaxRate, TargetDVR, CostLevEquity, BaseRate, _{—} |
| | kU_Change) |
| | Dim i, T1, T2, kU, DelAPV, z, N, DelN, j, k, kD |
| | T1 = Application.Count(CashFlow) |
| | T2 = Application.Count(DebtBookValue) |
| | ReDim TaxShield(T2) |
| ‘ | Output vector: |
| | ‘Row 1 = Enterprise value |
| | ‘Row 2 = Cost of unlevered equity |
| | ‘Row 3 = Cost of debt |
| | ‘Row 4 = Market value of debt |
| | ‘Row 5 = Cost of levered equity |
| | ReDim xyz(5, T1 + 1) |
| | For i = 1 To T2 |
| | TaxShield(i) = DebtBookValue(i) * InterestRate(i) * TaxRate(i) |
| | xyz(3, i + 1) = BaseRate(i) + LeveragePremium(0.5, 1) |
| | Next i |
| ‘ | Calculate market values of debt |
| | xyz(4, T2) = (InterestRate(T2) * DebtBookValue(T2) + _{—} |
| | DebtBookValue(T2)) / (1 + xyz(3, T2 + 1)) |
| | For i = T2 − 1 To 1 Step −1 |
| | xyz(4, i) = (xyz(4, i + 1) + InterestRate(i) * _{—} |
| | DebtBookValue(i) − (DebtBookValue(i + 1) − _{—} |
| | DebtBookValue(i))) / (1 + xyz(3, i + 1)) |
| | Next i |
| | For i = (T2 + 1) To T1 |
| | xyz(3, i + 1) = BaseRate(i) + _{—} |
| | LeveragePremium(TargetDVR(i − T2), 1) |
| | Next i |
| | Do While Abs(kD − xyz(3, 2)) > 10 \hat{ } −6 |
| | kD = xyz(3, 2) |
| | z = ((xyz(4, 2) − xyz(4, 1)) − (DebtBookValue(2) − _{—} |
| | DebtBookValue(1))) − xyz(4, 1) * CostLevEquity + _{—} |
| | DebtBookValue (1) * InterestRate (1) |
| | kU = (BaseRate(1) + CostLevEquity) / 2 |
| | Do While Abs(xyz(2, 2) − kU) > 10 \hat{ } −5 |
| | xyz(2, 2) = kU |
| ‘ | Cost of unlevered equity |
| | For i = 3 To T1 + 1 |
| | xyz(2, i) = xyz(2, i − 1) + kU_Change(i − 1) |
| | Next i |
| ‘ | Recursive calculation of all enterprise values |
| | xyz(1, T1) = CashFlow(T1) / (xyz(2, T1 + 1) − GrowthRate _{—} |
| | − TargetDVR(T1 − T2) * xyz(3, T1 + 1) * TaxRate(T1)) |
| | DelAPV = (−1) * xyz(1, T1) / (xyz(2, T1 + 1) − GrowthRate) |
| | For i = (T1 − 1) To (T2 + 1) Step (−1) |
| | xyz(1, i) = (xyz(1, i + 1) + CashFlow(i)) / (1 + _{—} |
| | xyz(2, i + 1) − TargetDVR(i − T2) * xyz(3, _{—} |
| | i + 1) * TaxRate(i)) |
| | DelAPV = (−1) * xyz(1, i) / (1 + xyz(2, i + 1)) + _{—} |
| | DelAPV / (1 + xyz(2, i + 1)) |
| | Next i |
| | For i = T2 To 1 Step (−1) |
| | xyz(1, i) = (xyz(1, i + 1) + CashFlow(i) + _{—} |
| | TaxShield(i)) / (1 + xyz(2, i + 1)) |
| | DelAPV = (−1) * xyz(1, i) / (1 + xyz(2, i + 1)) + _{—} |
| | DelAPV / (1 + xyz(2, i + 1)) |
| | Next i |
| ‘ | Update iteration |
| | N = xyz(1, 1) − z / (xyz(2, 2) − CostLevEquity) |
| | DelN = DelAPV + z / (xyz(2, 2) − CostLevEquity) \hat{ } 2 |
| | kU = xyz(2, 2) − N / DelN |
| | k = k + 1 |
| | Loop |
| ‘ | Recalculate market values of debt |
| | xyz(4, T2) = (InterestRate(T2) * DebtBookValue(T2) + _{—} |
| | DebtBookValue(T2)) / (1 + xyz(3, T2 + 1)) |
| | For i = T2 − 1 To 1 Step −1 |
| | xyz(4, i) = (xyz(4, i + 1) + InterestRate(i) * _{—} |
| | DebtBookValue(i) − (DebtBookValue(i + 1) − _{—} |
| | DebtBookValue(i))) / (1 + xyz(3, i + 1)) |
| | Next i |
| | For i = 1 To T2 |
| | xyz(3, i + 1) = BaseRate(i) + LeveragePremium(xyz(4, i), _{—} |
| | xyz(1, i)) |
| | Next i |
| | j = j + 1 |
| | Loop |
| | For i = T2 + 1 To T1 |
| | xyz(4, i) = TargetDVR(i − T2) * xyz(1, i) |
| | Next i |
| | xyz(2, 1) = j |
| | xyz(3, 1) = k |
| ‘ | Cost of levered equity |
| | ReDim x(4, T1 + 1) |
| ‘ | Output vector: |
| | ‘Row 1 = Book value of debt |
| | ‘Row 2 = Interest rate |
| | ‘Row 3 = Change of book value |
| | ‘Row 4 = Equity |
| | For i = i To T2 |
| | x(1, i) = DebtBookValue(i) |
| | x(2, i + 1) = InterestRate(i) |
| | Next i |

```
    For i = T2 + 1 To T1
        x(1, i) = xyz(4, i)
        x(2, i + 1) = xyz(3, i + 1)
    Next i
    x(1, T1 + 1) = x(1, T1) * (1 + GrowthRate)
    For i = 1 To T1
        x(3, i + 1) = x(i, i + 1) − x(1, i)
        x(4, i) = xyz(1, i) − xyz(4, i)
    Next i
    x(4, T1 + 1) = x(4, T1) * (1 + GrowthRate)
    For i = 1 To T1
        xyz(5, i + 1) = (CashFlow(i) − x(1, i) * x(2, i + 1) * _{—}
            (1 − TaxRate(i)) + x(3, i + 1) + x(4, i + 1)) / _{—}
            x(4, i) − 1
    Next i
    Overall = xyz
End Function
Function LeveragePremium(Debt, Value)
    Dim y, z
    y = −6.602165
    z = 4.227849
    LeveragePremium = Exp(y + z * Debt / Value)
End Function
```

I claim:

1. An automated method for simultaneously determining the current value for an enterprise and the current cost of unlevered equity for said enterprise based on a cash-flow forecast comprising:
(a) selecting a value for said current cost of unlevered equity,
(b) determining a value for the cost of unlevered equity for said enterprise for each subsequent time period contained within said cash-flow forecast based on a change over the value of a prior cost of unlevered equity,
(c) determining a current value for said enterprise using the capital cash flow method, the discounted cash flow method, or a combination or variation thereof,
(d) determining a current equity value for said enterprise by subtracting the current market value of debt of said enterprise as determined in the capital markets from said current value for said enterprise determined in step (c),
(e) determining a current cost of debt for said enterprise as a function of the ratio of the current market value of debt as determined in the capital markets to said current value for said enterprise determined in step (c),
(f) determining a value for the current cost of unlevered equity using the following equation:
$${k}_{1}^{U} = \frac{{E}_{0}}{{V}_{0}} {k}_{1}^{L} + \frac{{D}_{0}}{{V}_{0}} {k}_{1}^{D} ,$$
where E₀ is said current equity value for said enterprise determined in step (d), k₁^{L} is the current cost of levered equity for said enterprise as determined in the capital markets, D₀ is said current market value of debt as determined in the capital markets, k₁^{D} is said current cost of debt for said enterprise determined in step (e), and V₀ is said current value for said enterprise determined in step (c), and
(g) if the value of the current cost of unlevered equity determined in step (f) is not approximately equal to the current cost of unlevered equity selected in step (a), adjusting said current cost of unlevered equity selected in step (a), and repeating steps (a) through (g) until said cost of unlevered equity determined in step (f) approximately equals said current cost of unlevered equity selected in step (a).

2. An automated method for simultaneously determining the current value for an enterprise and the value for the current cost of unlevered equity for said enterprise based on a cash-flow forecast comprising:
(a) selecting a value for said current cost of unlevered equity,
(b) determining a value for the cost of unlevered equity for said enterprise for each subsequent time period contained within said cash-flow forecast based on a change over the value of a prior cost of unlevered equity,
(c) determining a current value for said enterprise using the capital cash flow method, the discounted cash flow method, or a combination or variation thereof,
(d) determining a current equity value for said enterprise by deducting the current market value of debt of said enterprise as determined in the capital markets from said current value for said enterprise determined in step (d), and
(e) if said current equity value determined in step (d) is not approximately equal to the current market capitalization of the equity for said enterprise, adjusting said current cost of unlevered equity in step (a), and repeating steps (a) through (e) until said current equity value determined in step (d) approximately equals said current market capitalization of the equity for said enterprise.

3. An automated method for simultaneously determining the current value for an enterprise and the value for the current cost of unlevered equity for said enterprise based on a cash-flow forecast comprising:
(a) selecting a value for said current cost of unlevered equity,
(b) determining a value of the cost of unlevered equity for said enterprise for each subsequent time period contained within said cash-flow forecast based on a change over the value of a prior cost of unlevered equity,
(c) determining a current value for said enterprise using the capital cash flow method, the discounted cash flow method, or a combination or variation thereof,
(d) determining a current cost of debt for said enterprise as a function of the ratio of the current market value of debt as determined in the capital markets to said current value for said enterprise determined in step (c), and
(e) if the current cost of debt determined in step (d) is not approximately equal to the current cost of debt for said enterprise as determined in the capital markets, adjusting said current cost of unlevered equity selected in step (a), and repeating steps (a) through (e) until said current cost of debt determined in step (d) approximately equals said current cost of debt for said enterprise as determined in the capital markets.

4. An automated method for simultaneously determining the current value for an enterprise and the value for the current cost of unlevered equity for said enterprise based on a cash-flow forecast comprising:
(a) selecting a value for said current cost of unlevered equity,
(b) determining a value of the cost of unlevered equity for said enterprise for each subsequent time period contained within said cash-flow forecast based on a change over the value of a prior cost of unlevered equity,
(c) determining a current value for said enterprise using the capital cash flow method, the discounted cash flow method, or a combination or variation thereof,
(d) determining a current market value of debt for said enterprise so that the current cost of debt for said enterprise when determined as a function of the ratio of said current market value of debt and said current value for said enterprise equals the current cost of debt for said enterprise as determined in the capital markets,
(e) determining a current equity value for said enterprise by deducting said current market value of debt of said enterprise from said current value for said enterprise,
(f) determining a value for the current cost of unlevered equity using the following equation:
$${k}_{1}^{U} = \frac{{E}_{0}}{{V}_{0}} {k}_{1}^{L} + \frac{{D}_{0}}{{V}_{0}} {k}_{1}^{D} ,$$
where E₀ is said current equity value for said enterprise determined in step (e), k₁^{L} is the current cost of levered equity for said enterprise as determined in the capital markets, D₀ is said current market value of debt of said enterprise determined in step (d), k₁^{D} is the current cost of debt for said enterprise as determined in the capital markets, and V₀ is said current value for said enterprise determined in step (c), and
(g) if the value of the current cost of unlevered equity determined in step (f) is not approximately equal to the current cost of unlevered equity selected in step (a), adjusting said current cost of unlevered equity selected in step (a), and repeating steps (a) through (g) until said cost of unlevered equity determined in step (f) approximately equals said current cost of unlevered equity selected in step (a).

5. An automated method for simultaneously determining the current value for an enterprise and the value for the current cost of unlevered equity for said enterprise based on a cash-flow forecast comprising:
(a) selecting a value for said current cost of unlevered equity,
(b) determining a value of the cost of unlevered equity for said enterprise for each subsequent time period contained within said cash-flow forecast based on a change over the value of a prior cost of unlevered equity,
(c) determining a current value for said enterprise using the capital cash flow method, the discounted cash flow method, or a combination or variation thereof,
(d) determining a current market value of debt of said enterprise by deducting the current market capitalization for the equity of said enterprise from said current value for said enterprise determined in step (c),
(e) determining a current cost of debt for said enterprise as a function of the ratio of said current market value of debt determined in step (d) to said current value for said enterprise determined in step (c),
(f) determining a value for the current cost of unlevered equity using the following equation:
$${k}_{1}^{U} = \frac{{MC}_{0}}{{V}_{0}} {k}_{1}^{L} + \frac{{D}_{0}}{{V}_{0}} {k}_{1}^{D} ,$$
where MC₀ is said current market capitalization for the equity of said enterprise, k₁^{L} is the current cost of levered equity for said enterprise as determined in the capital markets, D₀ is said current market value of debt of said enterprise determined in (d), k₁^{D} is said current cost of debt for said enterprise determined in step (e), and V₀ is said current value for said enterprise determined in step (c), and
(g) if the value of the current cost of unlevered equity determined in step (f) is not approximately equal to the current cost of unlevered equity selected in step (a), adjusting said current cost of unlevered equity selected in step (a), and repeating steps (a) through (g) until said cost of unlevered equity determined in step (f) approximately equals said current cost of unlevered equity selected in step (a).

6. An automated method for simultaneously determining the current value for an enterprise and the value for the current cost of unlevered equity for said enterprise based on a cash-flow forecast comprising:
(a) selecting a value for said current cost of unlevered equity,
(b) determining a value of the cost of unlevered equity for said enterprise for each subsequent time period contained within said cash-flow forecast based on a change over the value of a prior cost of unlevered equity,
(c) determining a current value for said enterprise using the capital cash flow method, the discounted cash flow method, or a combination or variation thereof,
(d) determining a current market value of debt of said enterprise so that the current cost of debt for said enterprise when determined as a function of the ratio of said current market value of debt of said enterprise and said current value for said enterprise determined in step (c) equals the current cost of debt of said enterprise as determined in the capital markets,
(e) determining a current equity value for said enterprise by deducting the current market value of debt of said enterprise determined in step (d) from said current value for said enterprise determined in step (c),
(f) if said current equity value determined in step (e) is not approximately equal to the current market capitalization of the equity of said enterprise, adjusting said current cost of unlevered equity in step (a), and repeating steps (a) through (f) until said current equity value determined in step (e) approximately equals said current market capitalization of the equity of said enterprise.

7. An automated method for simultaneously determining the current value for an enterprise and the current cost of unlevered equity for said enterprise based on a cash-flow forecast and a value parameter selected from the group consisting of the current cost of levered equity for said enterprise, the current market capitalization of the equity for said enterprise, the current cost of debt for said enterprise, and the current market value of debt for said enterprise, comprising:
(a) selecting a value for said current cost of unlevered equity,
(b) determining a value for the cost of unlevered equity for said enterprise for each subsequent time period contained within said cash-flow forecast based on a change over the value of a prior cost of unlevered equity,
(c) determining a value for said enterprise at the beginning of each time period commencing prior to the time at which the existing debt matures using the capital cash flow method, the discounted cash flow method, or a combination or variation thereof,
(d) determining combinations of cost of debt for each time period between time t and t+1 commencing prior to the time at which the existing debt of said enterprise matures and market value of debt at the beginning of each of said time periods that satisfy the equations:
$${D}_{t} = \frac{{d}_{t} {i}_{t + 1} - Δ {d}_{t + 1} + {D}_{t + 1}}{1 + {k}_{t + 1}^{D}}$$
$$and$$
$${k}_{t + 1}^{D} = f ( {D}_{t} / {V}_{t} ) ,$$
where dₜ is the book value of debt of said enterprise at time t, iₜ₊₁ is the interest rate for said debt for the time period between time t and time t+1, Δdₜ₊₁ is the change of the book value of debt over said time period, Dₜ₊₁ is the market value of debt of said enterprise at time t+1, kₜ₊₁^{D}, is the cost of debt over said time period, f(Dₜ/Vₜ) is a function determining the cost of debt for said time period based on leverage, expressed as the ratio of market value of debt at time t, Dₜ, and enterprise value at time t, Vₜ,
(e) if the value parameter is the current cost of levered equity,
i. determining a current equity value for said enterprise by subtracting the market value of debt of said enterprise at time t=0 determined in step (d) from the value for said enterprise at time t=0 determined in step (c),
ii. determining a value for the current cost of unlevered equity using the following equation:
$${k}_{1}^{U} = {k}_{1}^{L} \frac{{E}_{0}}{{V}_{0}} - {k}_{1}^{D} \frac{{D}_{0}}{{V}_{0}} ,$$
where E₀ is said current equity value for said enterprise determined in step (e)(i), k₁^{L} is said value parameter, k₁^{D} is the cost of debt for said enterprise for said time period determined in step (d), D₀ is the market value of debt at time t=0 determined in step (d), and V₀ is the value for said enterprise at time t=0 determined in step (c), and
iii. if the value of the current cost of unlevered equity determined in step (e)(ii) is not approximately equal to said current cost of unlevered equity selected in step (a), adjusting said current cost of unlevered equity selected in step (a), and repeating steps (a) through (e) until said cost of unlevered equity determined in step (e)(ii) approximately equals said current cost of unlevered equity selected in step (a),
(f) if the value parameter is the current market capitalization,
i. determining a current equity value for said enterprise by subtracting the market value of debt of said enterprise at time t=0 determined in step (d) from the value for said enterprise at time t=0 determined in step (c), and
ii. if the value of said current equity value determined in step (f)(i) is not approximately equal to said value parameter, adjusting said current cost of unlevered equity selected in step (a), and repeating steps (a) through (f) until said equity value determined in step (f)(i) approximately equals said value parameter,
(g) if the value parameter is the current cost of debt, and if the cost of debt k₁^{D} determined in step (d) is not approximately equal to said value parameter, adjusting said current cost of unlevered equity selected in step (a), and repeating steps (a) through (g) until k₁^{D} determined in step (d) approximately equals said value parameter, and
(h) if the value parameter is the current market value of debt, and if the market value of debt D₀ determined in step (d) is not approximately equal to said value parameter, adjusting said current cost of unlevered equity selected in step (a), and repeating steps (a) through (h) until said market value of debt D₀ determined in step (d) approximately equals said value parameter.
